(19) United States
(12) Patent Application Publication
(10) Pub. No.: US 2007/0006498 A1
(43) Pub. Date: Jan. 11, 2007

(54) Erasable, flexible signs and banners including collapsible supports

(76) Inventor: Michael Collins, Reno, NV (US)

Correspondence Address: KLARQUIST SPARKMAN, LLP, 121 SW SALMON STREET, SUITE 1600, PORTLAND, OR, 97204, US

(21) Appl. No.: 11/385,294

(22) Filed: Mar. 20, 2006

Related U.S. Application Data
(60) Provisional application No. 60/663,809, filed on Mar. 18, 2005.
(60) Provisional application No. 60/684,049, filed on May 23, 2005.

(51) Int. Cl. G09F 15/00

(52) U.S. Cl. 40/610

(57) ABSTRACT

A sign and methods of making and use. The sign has a central medium that may be written upon. The sign may be folded or rolled up when not is use, expanded into a sign configuration for use, and collapsed for later use or transport. The sign may have pre-arranged indicia on various portions, and other indicia may be added if desired when in use. The sign may have a surface that can be written upon and erased for re-use with other indicia, and it can include pockets or other structures for inserting predetermined indicia to shown on either the front of back side of the sign.

### CROSS REFERENCE TO RELATED APPLICATIONS

The present application claims the benefit of the applicant's prior provisional patent applications, Ser. No. 60/663,809, filed Mar. 18, 2005, entitled SIGN AND METHOD OF SUPPORTING AND USE, and Ser. No. 60/684,049, filed May 23, 2005, entitled ERASABLE, FLEXIBLE SIGNS AND BANNERS INCLUDING COLLAPSIBLE SUPPORTS, both of which prior provisional patent applications are hereby incorporated by reference in their entirety.

### FIELD

The present invention pertains to signs, banners, and the like on which one or more messages may be written, printed, or otherwise displayed for viewing by others. The present invention also pertains to stands or devices for supporting such displays, and to methods of use of such signs, banners, displays, and devices.

### BACKGROUND

The need for signs, placards, and banners is endless, and the use of signs, placards, and banners is ubiquitous in modern society. Signs, placards, banners, and the like are used for any of various purposes such as advertising, informing, warning, greeting, notifying, directing, exciting, comforting, propagandizing, protesting, and the like.

Often, banners and signs are created on the spot using whatever materials are at hand. Unfortunately, such a manner of creating a sign or banner usually results in a sign or banner that is poorly configured for its intended purpose or environment. For example, signs and banners often are hastily written on a flexible medium such as paper, which blows freely in the wind and collapses under its own weight, thereby presenting substantial difficulty in keeping the sign or banner readable.

Various human activities present frequent needs for signs and banners that are created and used spontaneously, and certain persons encounter frequent needs for such signs or banners. For such persons, it is not always convenient or easy to have sign-making materials on hand. For example, whereas rigid media are often preferred for signs, it is difficult to impossible to carry around a supply of rigid media (especially large, heavy, and/or bulky media) on which signs can be written on a moment's notice. Furthermore, rigid media of an appropriate size for a particular sign may be too heavy and/or awkward for holding by hand, especially over a lengthy period.

Another impediment to spontaneous sign-making is the lack of sign-making media that are erasable or otherwise amenable to changing the message on the sign, reusable, and collapsible for easy transport, storage, or re-use.

### SUMMARY

Various portable, collapsible, light-weight, re-usable signs and banners are disclosed as well as apparatus and methods of mounting, transporting, and using such devices.

In certain embodiments, the signs and banners (collectively referred to herein as “signs”) may be configured for hand-held use and may be erasable. Thus, in certain embodiments, the message, text, logo, design, or the like (collectively referred to herein as the “message”) displayed on the sign can be changed at will. In certain embodiments, the signs are re-usable a number of times.

In certain embodiments, the subject signs generally comprise a flexible, light-weight “medium” (surface on which the message is written) that may be of the “dry-erasable” type. The latter type of medium may allow the message to be changed as desired at any time simply by erasing the previous message and writing a new message using, for example, a dry-erasable marker. The medium may be sufficiently flexible to allow it to be rolled, folded, or otherwise collapsed when not in use.

As an alternative or in addition to applying the message to the medium or other portion of the sign by writing, the medium can be configured to allow any of various self-adhesive labels and the like, providing the message, to be applied to the sign. The adhesive used in such labels may be sufficiently tenacious to keep the label attached to the sign during actual use conditions, while still allowing the label to be removed without leaving adhesive or label residue on the medium.

Further, the sign can be configured with small lighting devices such as, but not limited to, LEDs and the like for creating and displaying the message on the sign. Further, the message can be written or printed on paper, thin cork, or other substance attached to or forming a part of the sign. Further, the sign can be configured with a magnetic property that allows messages to be “adhered” thereto magnetically. In any event, the message can be displayed on one surface (e.g., the “front” surface) or both surfaces (front and rear) of the sign.

The subject signs also comprise any of various collapsible support members that render the sign surface sufficiently taut for display purposes. The support members can be, for example, configured as any of rods, dowels, strips, ribs, inflatable members, struts, wind-up or roll-up mechanisms, and any other structure capable of holding the medium taut sufficiently while, if desired, still allowing easy disassembly for storage purposes and easy assembly for use of the sign. Certain types of support members (e.g., rods, slats, and dowels) can have a bowed or other tensioning characteristic that keep the medium or other desired portion of the sign under tension and that can, if desired, render the sign more movable, e.g., in a breeze, and thus confer on the sign a greater attention-getting characteristic and/or greater visibility than a conventional rigid sign.

In some embodiments, the support members are configured to allow the sign to be readily disassembled when not in use and conveniently stored, with minimal bulk and weight, in a convenient sleeve, pouch, or envelope that can be carried about or otherwise transported easily. If desired, such signs can be substantially lower in weight than conventional rigid signs of comparable size.

The support members can be attached to the medium in any of various ways including, but not limited to, insertion into sleeves or pockets in the medium, interaction with loops, clips, clamps, or the like, integral attachment (e.g., inflatable supports integrally formed in or otherwise secured to the medium), etc. One or more support members can be hinged, pinned, or otherwise made capable of being folded or collapsed, to facilitate assembly and disassembly. For example, a support member can be a dowel including a mid-length hinge or the like, wherein the hinge can be spring-loaded to favor a particular position. As another example, multiple support members can be linked together using an elastomeric cord or the like to facilitate self-assembly. The various possible configurations of support members provide a way to keep the medium open and displayed in a self-supporting manner.

Possible uses of the sign are endless, such as (but not limited to) sporting events, children's activities, travel emergencies, political rallies, protest gatherings, family events, competitions, business meetings, conventions, cheerleading, retail signage, limousine services, advertising, etc. For any of these uses, embodiments of the signs can be economical and efficient to make and use, easy to use (assembly and disassembly), strong, light-weight, easy and inexpensive to manufacture, flexible in terms of range of uses, adaptable, functional, durable, reliable, and noticeable. In certain embodiments, the range of possibilities in terms of messages and designs (including colors) that can be displayed on the medium is endless.

In certain embodiments, differing types of banners, signs, etc. (collectively for ease of reference “banner), can be mounted in various ways. The differing ways include, in addition to hand held or manipulated methods noted above, supporting the banner by a rod, a base stand, a suction cup stand, a clip stand with or without a magnet in the base of the stand, a hung with string or other supporting flexible or rigid structure at opposed sides of the banner, hung with suction cups, easel supported, and supported in tension via perimeter magnet mounts or other fastening devices. Certain embodiments allow for mounting of a banner without need for framing or other supporting structure.

Certain embodiments can be easy to manufacture, package, transport, and use. They may also be economical, light weight, and safe to use.

Certain embodiments may provide new ways of use of signs. They may also provide new methods of doing business, such as new methods of advertising. For example, advertising indicia may be place on one or more sections of the sign, and yet the sign may still provide ample area for a user to display a differing message on the sign. The advertising indicia, or user message, may be placed on differing sections or sides of the sign. In certain embodiments, one side of the sign can provide for display of the user's message as the dominant message from the sign, and yet the other side of the sign can display a different message or advertising, or both, in varying relationships as desired.

Certain embodiments can include sign pockets or other means for inserting or mounting differing types of messages or advertisements in the front or the rear of the sign. In one embodiment, a pocket on the back side of the sign may allow for insertion of one or more mating cardboard or other indicia members, and such members may also provide additional support and rigidity to the sign. In certain embodiments, this type of pocket-and-insert structure may even provide the primary of even sole means of expanding and supporting the sign in configuration for use to display a user's message or advertising.

There are other aspects of the present invention and the various disclosed embodiments. They will become apparent as this specification proceeds. In this regard, it is to be understood that certain embodiments of the invention need not necessarily address all issues in the Background section nor include all features or provide all advantages noted in this brief Summary.

### BRIEF DESCRIPTION OF THE DRAWINGS

The preferred and other embodiments are shown in the accompanying drawings in which:

FIG. 1A is a plan view of the back side of a sign according to a first exemplary embodiment;

FIG. 1B is a side view of the sign of FIG. 1A;

FIG. 1C is an elevational view of the front side of the sign of FIG. 1A;

FIG. 2 is a plan view of the rear or back side of a sign according to a second exemplary embodiment;

FIG. 3 is a plan view of a sign according to a third exemplary embodiment in which peripheral sign support rods are rotatable into position at the edges of the sign medium;

FIG. 4A is a back side plan view of a sign according to a fourth exemplary embodiment;

FIG. 4B is a side plan view of a support rod of the sign of FIG. 4A when the rods mounted into a flexed position biasing the sign medium into a relatively taut rectangular form factor;

FIG. 5 is a partial view of the end of a supporting rod of the sign of FIG. 4A and depicts details of an exemplary end cap used in the fourth exemplary embodiment;

FIG. 6 is a partial plan view of a corner of the rear of the sign shown in FIG. 4;

FIG. 7 is a plan view of the rear or back side of the sign shown in FIG. 4;

FIG. 8 is an elevational view of the entire front or indicia-bearing side of the sign shown in FIG. 4;

FIG. 9 is a plan view of the back side of a sign according to a fifth exemplary embodiment;

FIG. 10 is plan view of an exemplary notched end cap used in the fifth exemplary embodiment;

FIG. 11 is a plan view of a sign according to a sixth exemplary embodiment;

FIG. 12 is a partial plan view of a corner of the sign shown in FIG. 11;

FIG. 13 depicts details partial plan view of an exemplary elbow used in the sixth exemplary embodiment of FIG. 11;

FIG. 14 is a plan view of the front side of the sign shown in FIG. 11;

FIG. 15A is a back side view of a sign according to a seventh exemplary embodiment;

FIG. 15B is front side plan view of the sign of FIG. 15A;

FIG. 16 is an elevational view a sign according to an exemplary eighth exemplary embodiment;

FIG. 17 is a plan view of the backside of the sign (inflated) in FIG. 16;

FIG. 18 is a plan view of the sign of FIG. 16;

FIG. 19 is an elevational view of the back side of the sign of FIG. 16 showing the central pocket in which indicia or other sheet or board can be placed.

### DETAILED DESCRIPTION

Described below are various embodiments of portable, collapsible, light-weight, re-usable signs and banners. To simplify the description, the term “sign” shall be used in a generic sense to encompass various signs, banners, placards, and the like. Although the various embodiments are depicted as having rectangular shape or profile, it will be understood that the subject signs can have any practical shape or profile, including square, other polygonal, round, or the other suitable shape.

In addition, whereas most of the embodiments described below are depicted as having substantially the entire medium being held taut in an “assembled” sign, it is recognized that, in certain applications, one or more portions of the medium may be left in a relaxed (contrasted with taut) condition for additional attention-getting impact. For example, one portion of an opened sign may be left hanging in the manner of a loose banner from the taut portion for additional impact.

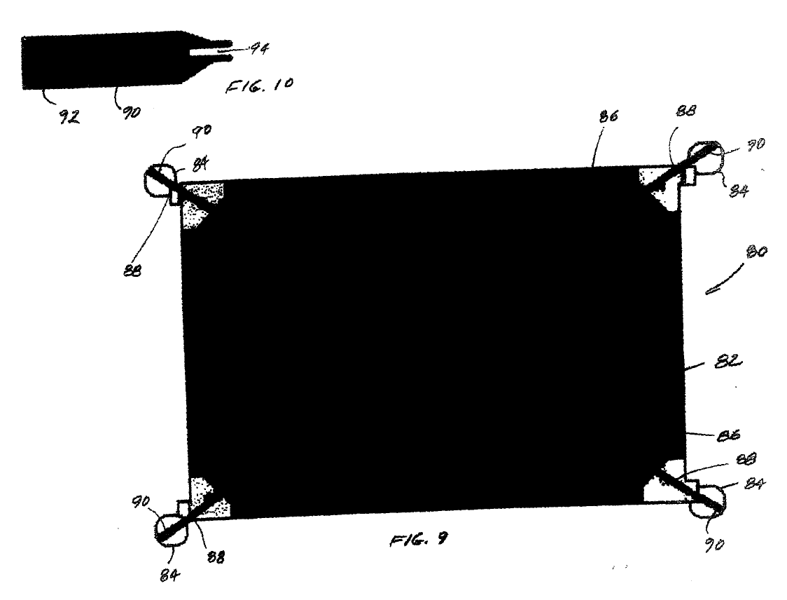

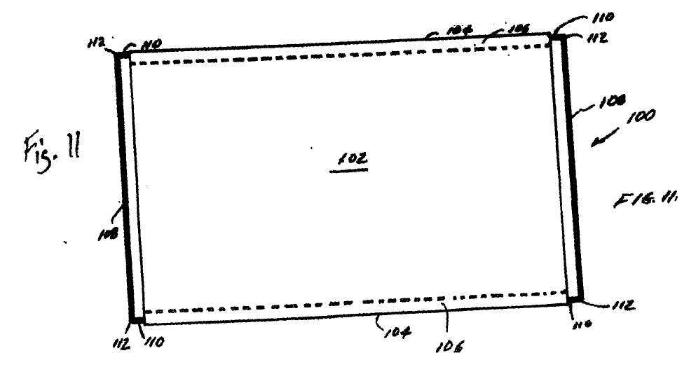

In the following embodiment, the medium comprises a material on which a message can be written using a dry-erasable marker such as a typical “white-board” marker. By way of example, the medium can comprise a flexible plastic sheet that, if desired or necessary, is formed on or has embedded in it a reinforcing structure such as netting (see, for example, FIG. 6) or other reinforcing threads, wires, or the like. A dry-erasable (or other erasable) surface can be provided by making such a surface integrally with the medium itself or, for example, by adhering a separate dry-erasable layer onto an existing flexible sheet. Such a surface can be provided on one side or alternatively on both sides of the medium. Furthermore, on either or both surfaces of the medium, the dry-erasable surface need not be provided over the entire surface. Rather, the dry-erasable surface can be provided in one or more discrete “zones”. Furthermore, the erasable surface need not be dry-erasable; other types of erasable surfaces alternatively can be used. An example sign comprising a dry-erasable medium on which a message has been written using a dry-erasable marker of FIG. 8.

In one group of embodiments the subject signs comprise light-weight, durable, flexible media that are rendered taut by using one or more readily collapsible and/or removable support members that also are easily assembled and disassembled. The support members can be any of various configurations of easily assembled ribs, rods, slats, dowels, or struts that are attached as needed to the medium, or such structures that “assemble” automatically upon opening up the sign.

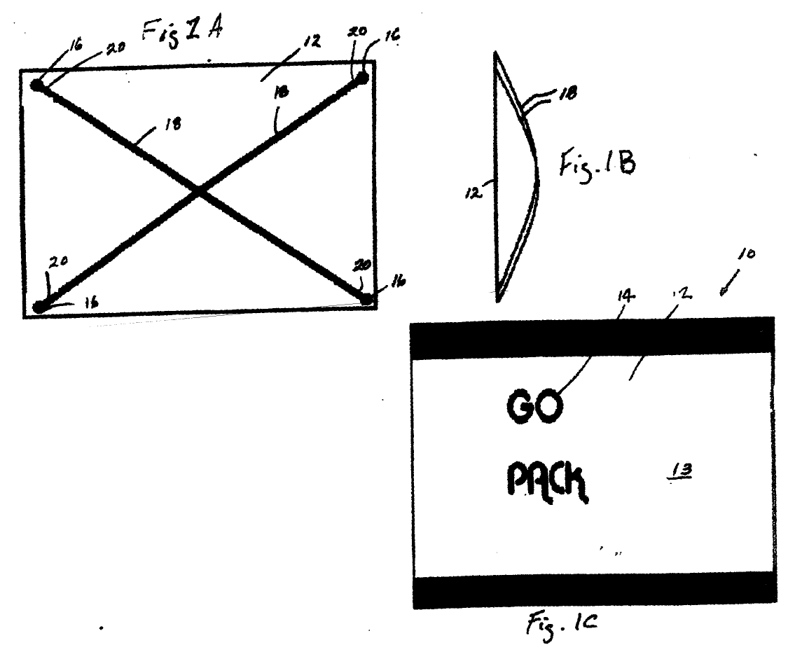

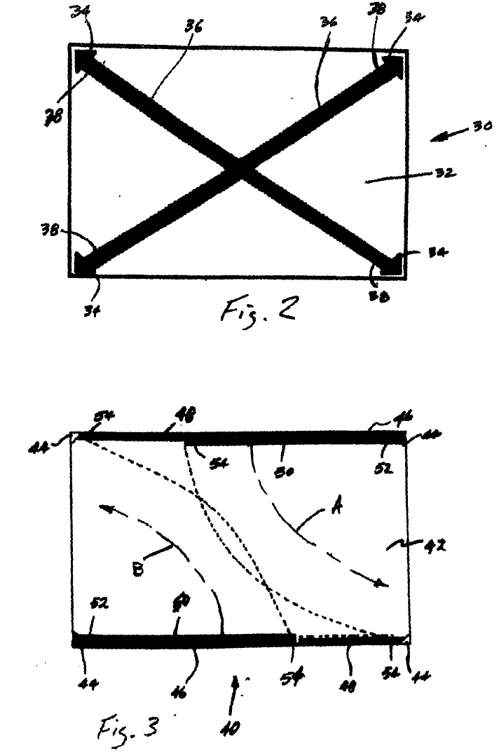

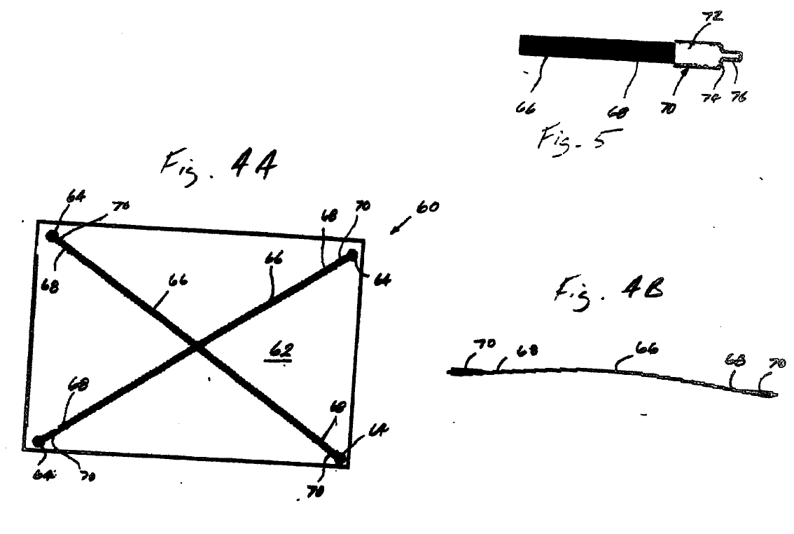

A first embodiment of a sign 10 is shown in FIGS. 1A-C, which comprises a rectangular flexible medium 12 on which can be placed (e.g., by printing or writing) a message 14. At least a sign zone 13 (on one or both sides) of the medium 12 can be surfaced with a material on which the message 14 can be written and from which the message 14 can be dry-erased (or otherwise easily removed) later to allow another, different message to be written on the medium at a subsequent time.

In the depicted embodiment of FIG. 1, the medium 12 defines four corner apertures 16, which can be reinforced by grommets or the like. The sign 10 also comprises a pair of semi-flexible rods or dowels 18 having respective termini 20. To assemble the sign 10, the rods are arranged in an “X” configuration, and the termini 20 are inserted into respective apertures 16. To prevent the apertures 16 from sliding down the rods 18 of an opened sign, the termini 20 can include respective hooks, ribs, pins, or the like (not shown, but see description of the fourth exemplary embodiment, below) that engage the edge of the respective aperture 16 and thus keep the apertures 16 at the respective termini 20. In the assembled sign 10, the rods 18 desirably are flexed (bowed) somewhat, which places the corners of the medium 12 under tension and thereby keeps the medium taut. The rods 18 can be made of any of various materials including, but not limited to, metal, wood, fiberglass, or plastic.

Because the rods 18 are flexible, disassembling them from the apertures 16 is simple and easy. Namely, the ends of the rods 18 are manually flexed sufficiently to withdraw the termini 20 from the respective apertures 16. The medium 12 may then be rolled up or folded and stored compactly with the rods 18 in, for example, an appropriately sized sleeve, carton, or envelope.

If desired, the rods 18 can be pivotally connected together with a pin or the like (not shown) at mid-length to connect the rods together in a scissors manner. Such connection does not adversely affect assembly or disassembly of the sign 10 and advantageously keeps the rods together during storage.

Also, it is recognized that at least one of the rods 18 can be articulated with a spring hinge or the like somewhere along its length to facilitate flexing the rod during assembly and/or disassembly. It also is recognized that both rods 18 can be articulated in such a manner, which could facilitate leaving at least some the termini 20 in the apertures 16 even during “disassembly” of the sign 10. Indeed, the spring in such a hinge could be configured, analogously to mechanisms in certain types of umbrellas, to actuate upon the user depressing a button or disengaging a catch. Thus, the sign can be substantially instantly “assembled” on demand.

In any event, the sign 10 in the depicted configuration can be opened and assembled quickly and easily at a moment's notice, and can be collapsed easily and stored in a minimal volume. The sign 10 is relatively low in cost compared to many types of signs on rigid media. The message 14 can be written in the zone 13 (on one side or both sides) easily and quickly using, for example, a dry-erasable marker. Also, using a dry-erasable marker allows the message 14 to be changed easily and quickly as required. Thus, a user can carry about only one sign 10 (comprising medium 12 and rods 18) that can be assembled and disassembled over and over again for different purposes such as, but not limited to, sporting events, emergency situations, political rallies, retail signage, limousine service, advertising, etc. With proper care, the sign 10 would last for years, even with repeated use.

A second exemplary embodiment of a sign 30 is shown in FIG. 2, which is similar in certain respects to the embodiment of FIG. 1. In FIG. 2, the sign 30 comprises a flexible medium 32 on which can be placed (e.g., by printing or writing) a message (not shown). Attached to each corner of the medium 32 is a respective triangular corner pocket 34 attached (e.g., by stitching) along its two shorter sides to the medium 32. The sign 30 also comprises a pair of semi-flexible flat rods 36 having respective termini 38.

To assemble the sign 30, the rods 36 are arranged in an “X” configuration, and the termini 38 are inserted into respective pockets 34. In the assembled sign 30, the rods 36 desirably are flexed (bowed) somewhat, which places the corners of the medium 32 under tension and thereby keeps the medium 32 taut.

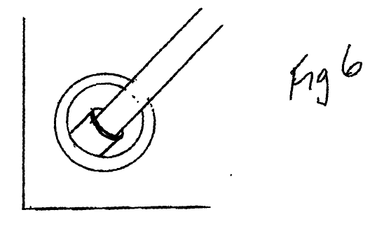

A third exemplary embodiment of a sign 40 is shown in FIGS. 3A and 3B. The sign 40 comprises a flexible medium 42 on which can be placed (e.g., by printing or writing) a message (not shown). Attached to each corner of the medium 42 is a respective triangular corner pocket 44 attached (e.g., by stitching) along its two shorter sides to the medium 42. The sign 40 also comprises a pair of semi-flexible rod assemblies 46 each comprising a first arm 48 and a second arm 50. With respect to each rod assembly 46, the arms 48, 50 have respective first ends 52 that are pivotally connected to each other in the manner of an articulated elbow and respective second, free, ends 54.

To assemble the sign 40, the elbowed first ends 52 are inserted into diametrically opposed pockets 44. The free ends 54 of the first arms 48 are seated in the other two opposing pockets 44. The second arms 50 are pivoted 900 relative to the respective first arms 48 to allow the free ends 54 of the second arms 50 to be inserted into respective pockets 44 as shown. Thus, in the assembled sign 40, the arms 48, 50 are arranged along the periphery of the medium 42, which serves to keep the medium 42 taut.

Disassembling the rod assemblies 46 from the pockets 44 is simple and easy. Namely, the free ends 54 of the second arms 50 are slipped out of the pockets 44 by pivoting the second arms 50 relative to the first arms 48, then removing the first arms 48 from the pockets 44. The medium 42 is then rolled up or folded and stored compactly with the rod assemblies 46 in, for example, an appropriately sized sleeve, carton, or envelope.

The first ends 52 can be hinged in a manner that prevents the arms 48, 50 from opening up more than 90° relative to each other. In addition, the 90° position can be provided with a detent or analogous feature to favor keeping the arms at 90° unless and until it is desired to disassemble the sign 40. In addition or alternatively, the hinges may be spring-biased to be preferentially in the 90° position, and wherein the 0° position can be maintained (e.g., during storage) using a detent or analogous feature.

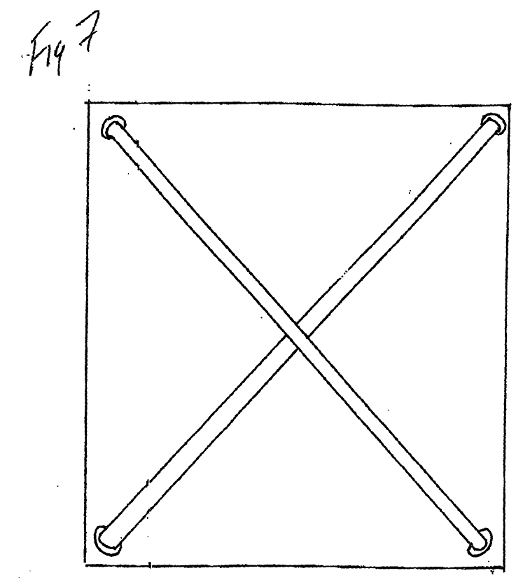

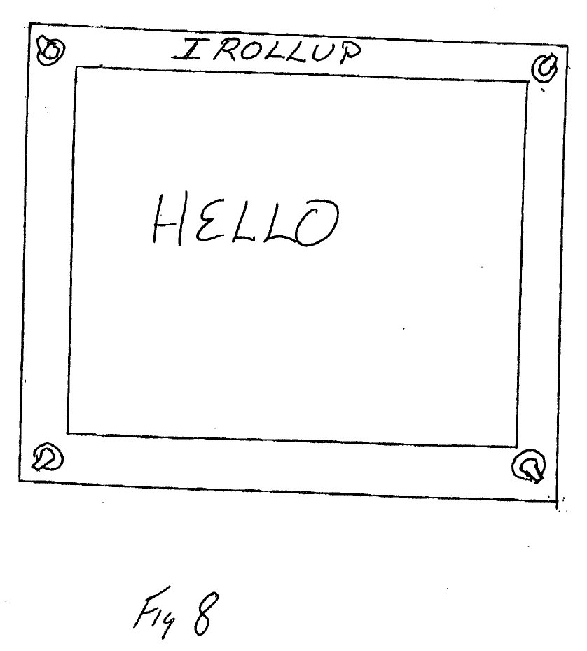

A fourth exemplary embodiment of a sign 60 is shown in FIGS. 4A and 4B, which can be similar in certain respects to the embodiment of FIG. 1. Specifically, the FIG. 4A-B embodiment 60 comprises a flexible medium 62 on which can be placed (e.g., by printing or writing) a message (not shown). The medium 62 defines four corner apertures 64, which can be reinforced by grommets or the like. The sign 60 also comprises a pair of semi-flexible rods 66 having respective termini 68 to each of which is attached a respective “end cap” 70. An exemplary end cap 70, depicted in FIG. 5, comprises a socket 72 in which the terminus 68 of the rod 66 is inserted, a shoulder 74, and a pin 76. The end cap can be made of any of various materials such as, but not limited to, plastic, metal, rubber or other elastomer, wood, or fiberglass. (Of course, if the rods 66 are configured with termini having shoulders and pins in the manner of the end caps 70, then separate end caps are not required.) The thickness (diameter) of the pin 76 is less than of the socket 72 or rod 66.

To assemble the sign 60, the rods 66 are arranged in an “X” configuration, and the pins 76 are inserted into respective apertures 64. One corner of the rear of an exemplary sign assembled in this manner is shown in FIG. 6, the rear of the exemplary FIG. 6 sign assembled in this manner is shown in FIG. 7, and the front of the sign of FIG. 7 is shown in FIG. 8, in which the medium has a message written on it using a dry-erasable marker. In the assembled sign 60, the rods 66 are flexed (bowed) somewhat, which places the corners of the medium 62 under tension and thereby keeps the medium 62 taut. Because the rods 66 are flexible, disassembling them from the apertures 64 is simple and easy. Namely, the ends of the rods 66 are manually flexed sufficiently to withdraw the pins 76 from the respective apertures 64. The medium 62 is then rolled up or folded and stored compactly with the rods 66 in, for example, an appropriately sized sleeve, carton, or envelope.

A fifth exemplary embodiment of a sign 80 is shown in FIG. 9, which comprises a flexible medium 82 on which can be placed (e.g., by printing or writing) a message (not shown). The medium 82 has four corners each provided with a respective loop or ring 84. The ring 84 can be made of any of various materials including, but not limited to, metal, fiber, or plastic (including fiber-reinforced plastic). The sign 80 also comprises a pair of semi-flexible rods 86 having respective termini 88 to each of which is attached a respective “end cap” 90.

An exemplary end cap 90 is depicted in FIG. 10, in which the end cap 90 comprises a socket 92 in which the terminus 88 of the rod 86 is inserted, and a terminal notch 94. By way of example, the notch 94 can be configured similarly to the nock on the end of an arrow. The gap (width) of the notch 94 is slightly greater than the thickness of the ring 84.

To assemble the sign 80, the rods 86 are arranged in an “X” configuration, and the rings 84 are inserted into respective notches 94. In the assembled sign 80, the rods 86 can be flexed as described above or left substantially unbowed, as desired, to maintain the corners of the medium 82 under at least slight tension. For example, the rings 84 can be elastic, which could eliminate the need for bowing the rods 86 to keep the medium 82 taut. Because the rods 66 are flexible, disassembling them from the rings 84 is simple and easy. Namely, the ends of the rods 86 are manually flexed sufficiently to withdraw the rings 84 from the respective notches 94. The medium 82 is then rolled up or folded and stored compactly with the rods 86 in, for example, an appropriately sized sleeve, carton, or envelope.

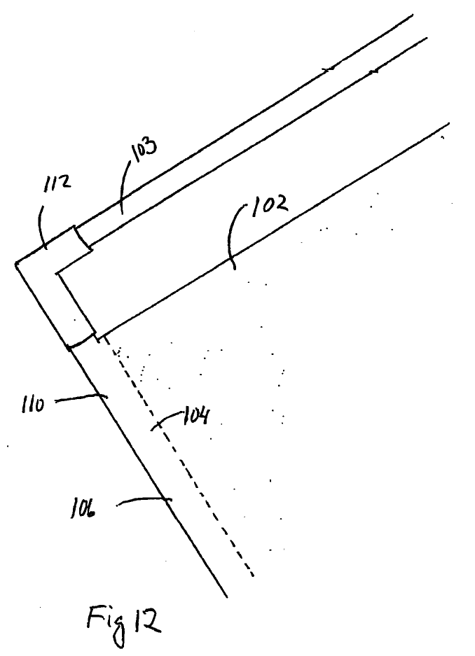

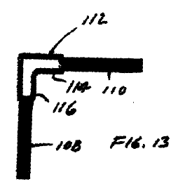

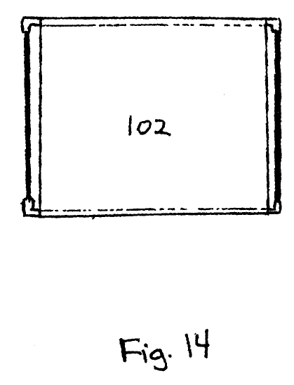

A sixth exemplary embodiment of a sign 100 is shown in FIGS. 11A and 11B, which sign 100 comprises a flexible medium 102 on which can be placed (e.g., by printing or writing) a message (not shown). The medium 102 defines, along at least two opposing edges (longitudinal edges shown) 104, respective sleeves 106. The sign 100 also comprises two first rods 108 and two second rods 110 that desirably have some flexibility while retaining substantial rigidity. The rods 108, 110 have respective ends that are connected together pair-wise using elbows 112. See FIG. 12, depicting a portion of a sign having these components.

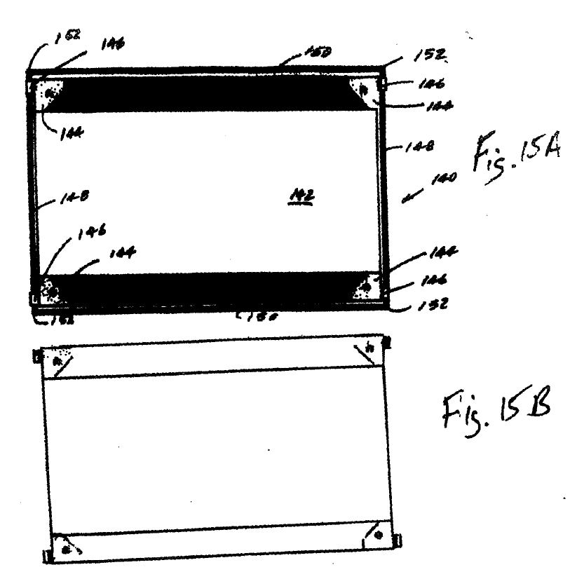

An exemplary elbow 112 is depicted in FIG. 13, in which the elbow 112 comprises a first socket 114 configured to receive an end of the second rod 110, and a second socket 116 configured to receive an end of the first rod 108. To assemble the sign 100, the second rods 110 are inserted into their respective sleeves 106, and the ends of the rods 108, 110 are inserted into respective elbows 112. The first rods 108 desirably have a length sufficient to be in a slightly flexed configuration so as to keep the medium 102 taut in the assembled sign 100 (see FIG. 14). Because the rods 108, 110 have some flexibility, disassembling them from the elbows 112 is simple and easy. Namely, the ends of the first rods 108 are manually flexed sufficiently to withdraw the ends from the respective elbows 112. (To prevent loss, the elbows 112 can be permanently attached to the ends of the second rods 110 or attached in a manner rendering it difficult to remove the elbows 112 from the second rods 110.) The medium 102 is then rolled up or folded and stored compactly with the rods 108, 110 in, for example, an appropriately sized sleeve, carton, or envelope.

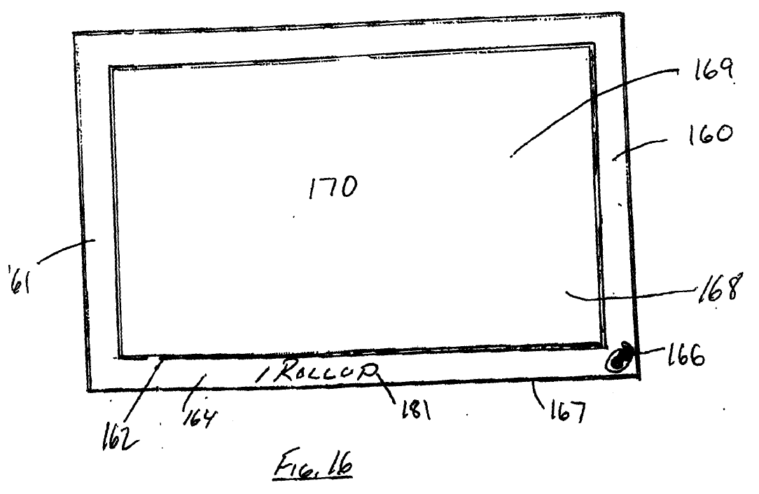

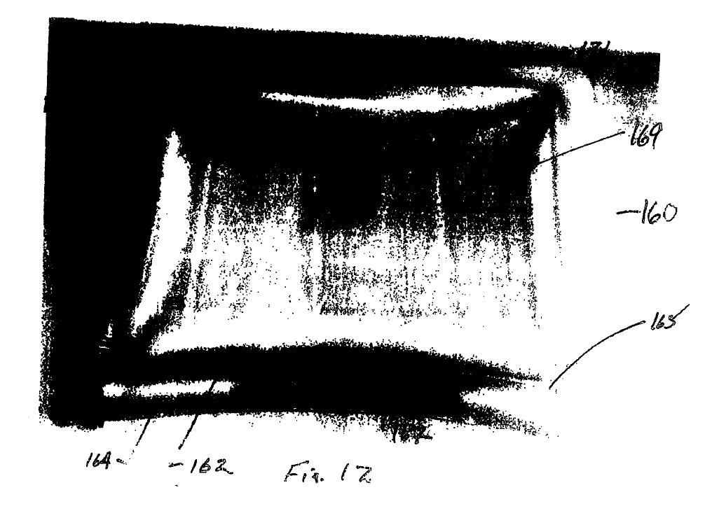

A seventh exemplary embodiment of a sign 120 is shown in FIGS. 15A and 15B, which sign 100 comprises a flexible medium 122 on which can be placed (e.g., by printing or writing) a message (not shown). The medium 122 defines, at each corner thereof, a respective aperture 124. The sign 100 also comprises two first rods 126 and two second rods 128 that desirably have some flexibility while retaining substantial rigidity. The rods 126, 128 have respective ends that are connected together pair-wise using elbows 130, such as shown, for example, in FIG. 13 and described above.

To assemble the sign 120, the second rods 128 are inserted into the aperture 124 as shown, and the ends of the rods 126, 128 are inserted into respective elbows 130. The first rods 126 desirably have a length sufficient to be slightly flexed in the assembled sign and thus keep the medium 122 taut in the assembled sign 120. Because the rods 126, 128 have some flexibility, disassembling them from the elbows 130 is simple and easy. Namely, the ends of the first rods 126 are manually flexed sufficiently to withdraw the ends from the respective elbows 130. The medium 122 is then rolled up or folded and stored compactly with the rods 126, 128 in, for example, an appropriately sized sleeve, carton, or envelope.

Another group of embodiments pertains to signs that are held, when inflated for use, held or arranged in a relatively expanded and sufficiently taut condition by a generally rectangular flexible inflated tube or bladder secured to the periphery of a central generally rectangular flexible medium. In this regard, however, the the bladder and the central medium may have other configurations, such as round, oval, or various other shapes, such as, without limitation, of various characters, things, or artistic configuration.

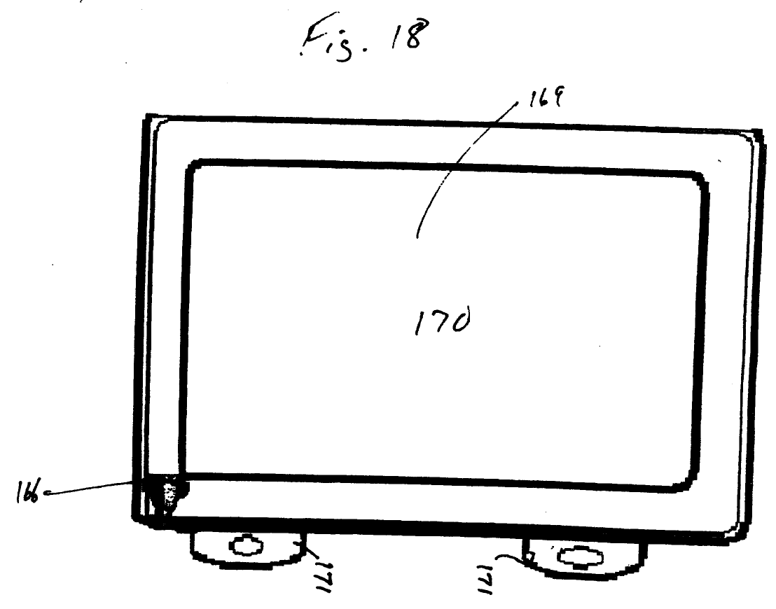

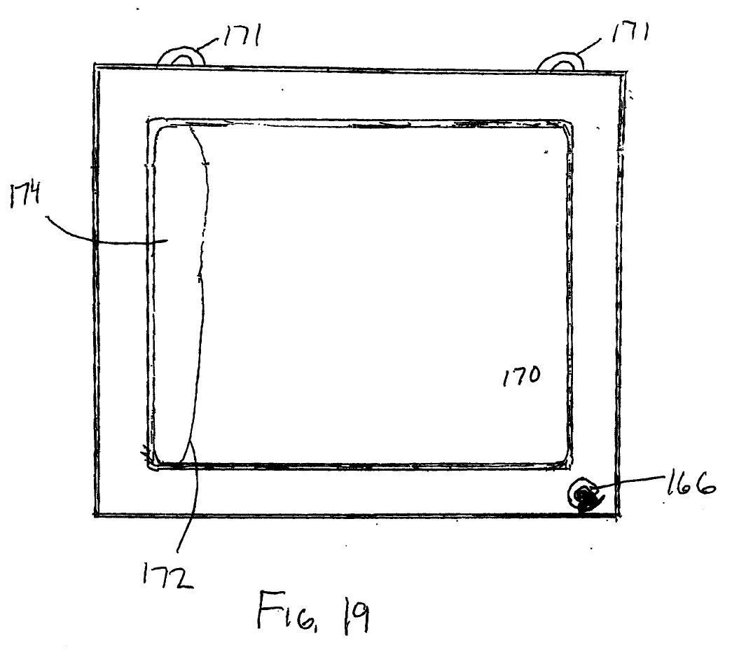

By way of example, a ninth exemplary embodiment of a sign 160 is shown in FIGS. 16-19, which comprises a flexible medium 170 on which can be placed (e.g., by printing or writing) a message (not shown). Extending around the periphery of the rectangular central portion 169 of the medium 170 is an inflatable bladder 160, which can be defined by the components of the medium 162 itself (e.g., by folding over and sealing material along the edges to form a tube providing the bladder 160) or attached to the medium's central portion 169.

The bladder 164 is provided with at least one inflation nipple 166 used for inflating the bladder 164. When the bladder 164 is fully inflated to an appropriate pressure, it behaves and functions, with respect to making the central portion 169 medium 162 sufficiently taut—generally planar or perhaps slightly curved in a manner analogous to the various rods described above with respect to other embodiments.

To “assemble” the sign 160, the bladder 164 is inflated by the user/operator to an appropriate pressure (usually achievable my inflating the tubing orally) by blowing air in the bladder 164 by the inflation nipple 166. To “disassemble” the sign 160, the nipple 166 is opened to allow the air to bleed from the bladder 164 as the bladder is compressed by the user. The medium 162 can then be rolled up or folded and stored compactly in, for example, an appropriately sized sleeve, carton, envelope, pocket, etc.

The inflatable bladder sides, e.g., 160, 161, and central sign portion, e.g., 169, components of these sign embodiments may be made of two sheets of plastic or other flexible material, provided that the inflatable bladder 164 retains air or other gas when injected or blown into the bladder 164. PVC sheeting may be used, and the internal and external mating edges, e.g., 165, 167, of the inflatable sides 160, 161 may be heat welded together, glued, etc.

In the embodiment of FIG. 16-19, the inflatable frame/support allows writing or other indicia on both sides of sign. In this particular embodiment, as shown in FIG. 16 a logo 181 or other indicia 182 (not shown, permanent or erasable) may be marked on one face 184 of the sign, and as shown in FIG. 19, the other, reverse side 186 may provide a yet another surface for placing logos or other writing indicia (permanent or dry erase.

As shown in FIG. 19, one side of sign may have sign pocket 174 formed in the central section 169 of the medium 170. The sign pocket 174 may be formed by a slit in PVC or other sheet so that an outer edge 172 of the sign pocket 174 may be pulled outwardly so that a sheet (such as a cardboard sheet) bearing advertising or other indicia (if desired) may be inserted in the sign pocket 174. In this regard, in certain embodiments, such a sheet (with or without indicia) may be sufficiently rigid to allow the sign to exclude the bladder structure and still provide a portable and collapsible sign that can have, if desired, a dry-erase surface that may be written up by the user.

Alternatively, additional frame supports may be added to one side to provide further strength and rigidity to the sign. In either embodiment, additional logos or writing surfaces may be provided by the inflatable sides. Additionally, handles, suspension passages, hanging tabs (see 171 in FIGS. 16-19), and other elements may be added to, or formed integrally with, the sign.

In an inflatable sign apparatus for example, handle passages can be formed in the inflatable bladder at opposing sides of the sign. An operator may thereby grasp the sign with a portion of the operator's hand, such as one or more fingers, penetrating a handle passage.

The signs of FIGS. 16-19 may be particularly light weight, weighing less than a pound. They may be folded up and stored in pants or other pocket or purse. They may be hand-held when used, and collapsed and re-inflated for use repeatedly during an event such as a sports game or political rally.

An inflatable embodiment, such as shown in FIGS. 16-18, can be made according to the following procedure:
Obtain raw materials—PVC vinyl 8 mil., Dry erase vinyl 4 mil. (Substrate of dry erase is PVC), 7 mm. PVC limit valve w/shut off.
Design and make a sealing die to seal and cut the shape and size of the perimeter of the sign (using 8 mil PVC vinyl and dry erase).
Design and make a die cut die for the shape and size of the perimeter of the dry erase.
Design and make RFW (Radio Frequency Welding) sealing die to seal two edges plus the center weld for the dry erase.
Cut 2 sheets of PVC vinyl using a fabric cutter for PVC vinyl
Die cut 1 sheet of dry erase using a die cutting die designed for dry erase finished size.
Punch a hole in one corner of one of the two sheets of 8 mil PVC vinyl where the 7 mm. PVC limit valve w/shut off will be placed.
Insert 7 mm. PVC limit valve w/shut off in the hole punched in the corner of one of the sheets and seal in place.
Place the dry erase in the center of the die than put two sheet of 8 mil of PVC vinyl on top of the dry erase and seal perimeter and at the same time seal the dry erase in place in the center of the sign.
Lay sheet of dry erase vinyl on top of sealing die in the center according to sealing die positioning.
Lay a sheet of 8 mil PVC vinyl (with valve) flat on top of the dry erase.
Lay a sheet of 8 mil PVC vinyl (with no hole) on top of all the sheets.
Sealing of the dry erase and vinyl perimeter are done at the same time.
RF weld using a RFW sealing die.
Trim any excess material after weld.
Print on front or back surface (vinyl only) with a printing process such as “hot stamp printing” or “silk screen printing.”
Package sign along with a dry erase marker.

A method of use of such a portable, lightweight, and reusable sign is as follows:

Assemble:

Unpackage sign and unfold or unroll the sign if so oriented.
Open PVC air valve w/shut off for inflation by pulling open attached valve cap.
Put mouth over valve and blow air into valve until fully inflated.
Close valve by inserting attached valve cap
Push air valve down so it recesses into air chamber or bladder.
Open cap of one or dry erase markers and write on dry erase surface of sign.
Display sign.
Erase indicia and re-mark and reuse sign as desired.
   Store Sign for Transport or Reuse
Pull on attached valve cap till open.
Squeeze air valve and bladder until air exits bladder.
Continue to squeeze valve and roll up sign allowing air to leave the chamber/bladder.
Sign is now ready for further packaging, storage, transport, or reuse.

Another group of embodiments pertains to signs incorporating a “wind-up” feature. By way of example, a tenth exemplary embodiment of a sign 270 (not shown) comprises a flexible medium 272 on which can be placed (e.g., by printing or writing) a message (not shown). The medium 272 defines, along at least two opposing edges (longitudinal edges shown) 274, respective sleeves 276 into which are inserted respective rods 278. The rods 278 can be left in the sleeves 276 at all times, even when the sign 270 is “disassembled.” Associated with the two other opposing edges 280 are respective “roll-up” tapes 282 similar or analogous to the tape portion of a “tape measure”, wherein the tape tends to remain in a rolled-up state, but can be extended to its full length or any intermediate length. As the tapes 282 roll up, they urge the medium 272 to roll up along with them.

To “assemble” the sign 200, the sign is grasped along the top edge 274 and the bottom edge 274 and pulled to unroll the medium 272 against the roll-up forces exerted by the roll-up tapes 282. If desired, the rods 278 can be fitted with elbows (not shown), and an additional pair of rods (not shown) can be placed adjacent the edges 280 and fitted to the elbows. To “disassemble” the sign 270, if no rods are used to keep the tapes 182 in an extended state, one simply allows the tapes 282 to roll back up, which rolls up the medium in a scroll manner. If rods or the like are used to keep the tapes 282 extended, it is first necessary to detach those rods, then to allow the tapes to roll up. The medium 282 is then stored compactly in, for example, an appropriately sized sleeve.

Another embodiment (eleventh exemplary embodiment) of a sign incorporating a roll-up mechanism (not shown), in which the sign 400 comprises a flexible medium 402 on which can be placed (e.g., by printing or writing) a message (not shown). The medium 402 is attached, along one edge 404, to a self-roll-up mechanism 406 similar to, for example, the mechanism used in a conventional window blind. The opposite edge 408 of the medium 402 can be provided with a sleeve into which is inserted a flat rod or bar 410 to rigidify the edge 408. The other two opposing edges of the medium 402 are left flexible. Thus, the medium 402 can be rolled up on the roll-up mechanism 406. To display the sign, the user grasps the edge 408 and pulls it away from the roll-up mechanism 406 while holding onto the roll-up mechanism. If desired, to maintain the medium 402 in the open condition without having manually to hold it open, one or more rods can be employed to hold the edge 408 at a desired distance from the roll-up mechanism 406. To close the sign 400, one simply allows the medium 402 to roll up on the roll-up mechanism 406. The sign 400 then can be stored compactly in, for example, an appropriately sized sleeve.

A framed sign 300 may be supported by one or more rods, e.g., 302, secured to the sign 300 by any of a variety of techniques, such as to the middle or central section of the sign 300 or to an end or side of a framed sign 300. The rod 302 may be inserted into the ground or other base material (not shown), may be attached to a planar, transversely extending rigid base stand 304, a resilient suction cup stand 306, or a clip stand 308 with magnet (for mounting on a metallic structure or without a magnet (not shown). The framed sign 300 may also be easily hung with string, chain, or other interconnecting structures secured to the framed sign 300 adjacent its opposing ends or sides 310, 312. Alternatively or in addition, suction cups 314, 315 may be mounted to supporting structures 316, 318 on a sign in order to mount the suction cups 314, 315 to a suitable mounting, such as for example a wall, a automobile, a ceiling, the back of a chair, etc.

A framed sign 300 may also be supported by an easel 319, or it may be supported by means of magnets or suction cups 320, 322, 324, or other supporting or fastening structures secured to strings of other interconnecting material or rods, which in turn are secured to the sign to support the sign in position. In this latter mounting arrangement, certain of the interconnecting strings, rods, or other material can secure the sign 300 in position by being in tension and thereby providing a means of centering and securing the frame in between oppositely tensioned strings, rods, or other material.

It should be noted that, in certain embodiments, the signs may include a magnetized material, such as on the back of or on portions of the back of, a sign. The magnetizable material may be secured to the back of the sign by being laminated or glued to the sign material, or a flexible magnetic sheet may provide both the magnetic backing as well as sign front or side on which indicia may be printed or written. This magnetized material can allow the signs to be mounted on or adjacent metallic material, such as the side of car, van, truck, etc. The sign can thereby be mountable on such a vehicle as well as used in the fashions described above if desired.

In certain embodiments, the sign may also have various mechanisms for providing fluorescent or illuminated or illuminatable indicia or elements on the sign face. For example, an organic or other type of LED, or fibre optics, may be mounted on or in association with, including extending from, the sign or associated structure. These light emitting devices may be powered by batteries or other power supply arrangements that can, if desired, be mounted to supporting or other structures for the sign. Such illuminating devices can render use of the sign more attractive and likely to be seen, particularly in a darkened room or arena.

The sign may include any of a variety of structures for removable mounting writing indicia to the sign. For example, a writing utensil, such as a dry-erase or other marker or pen, may be secured in a pocket or pen passage formed the sign or attached to the sign by a Velcro or other pen mounting member. Such a pen mounting member may be either fixedly attached to the sign, or it may be removably secured to the sign, such as by means of Velcro secured to the pen mounting member and to a mating section of the sign, such as peripheral portion of the sign or sign structure.

As noted above, the sign may include advertising for one or more advertisers. The use of the sign can thus provide a vehicle of advertising for the advertiser while providing a sign through which the user of the sign may present a message. The advertiser and the user may be distinct, providing a new way for advertisers to advertise through distribution or use of such signs.

It is to be understood that the foregoing is a detailed description of various, including the preferred, embodiments. The foregoing detailed description is therefore not to be itself limiting.

What is claimed is:

1. A collapsible sign, comprising:
a flexible medium having at least one surface on which a message can be displayed, the medium configured to be in an open condition when displaying the message and to be in a closed condition when not in use; and
at least one support member having a first configurational state that interacts with the flexible medium in a manner by which the medium is maintained in the open state to display the message and a second configurational state by which the medium can be placed in the closed condition.

2. The sign of claim 1, wherein the flexible medium comprises a dry-erasable zone in which the message can be written using a dry-erasable marker.

3. The sign of claim 1, wherein:
the medium includes multiple corners at some of which having respective support-member-attachment mechanisms;
the at least one support member comprises multiple elongated members having termini configured to attach to the respective support-member-attachment mechanisms to form the first configurational state.

4. The sign of claim 3, wherein the elongated members are selected from the group consisting of rods, ribs, dowels, and struts.

5. The sign of claim 4, wherein the elongated members are in tension in the first configurational state.

6. The sign of claim 3, wherein:
the medium is configured to define at least one sleeve; and
at least one elongated member is inserted into the sleeve in the first configurational state.

7. The sign of claim 6, wherein:
the medium defines multiple sleeves, including first and second sleeves extending along opposing sides of the medium;
a first group of elongated members are inserted into the respective sleeves; and
a second group of elongated members interact with the first group in a manner that urges the members of the first group apart so as to hold the medium open in a taut manner.

8. The sign of claim 3, wherein:
the medium comprises multiple corners each defining an orifice; and
in the first configurational state the elongated members have respective ends that are inserted into the orifices in an arrangement in which the elongated members hold the medium open in a taut manner.

9. The sign of claim 3, wherein:
the medium comprises multiple corners each defining a pocket; and
in the first configurational state the elongated members have respective ends that are inserted into the pockets in an arrangement in which the elongated members hold the medium open in a taut manner.

10. The sign of claim 1, wherein the at least one support member comprises a roll-up mechanism.

11. The sign of claim 1, wherein the at least one support member comprises an inflatable bladder.

12. The sign of claim 11, wherein the inflatable bladder extends peripherally around the medium.

13. A portable sign comprising in combination:
A. a collapsible dry-erase section; and
B. an expandable inflatable section securable to the dry-erase section, whereby the inflatable section may be inflated and expanded to de-collapse the dry-erase section.

14. The portable sign of claim 13 wherein the expandable inflatable section is secured to at least a portion of the periphery of the collapsible dry-erase section.

15. The portable sign of claim 14 wherein the collapsible dry-erase section has an external peripheral edge surrounding a central dry-erase sign section and the expandable inflatable section is secured to and surrounds the external peripheral edge of the collapsible dry-erase section.

16. The portable sign of claim 13 further comprising a sign pocket whereby an indicia bearing member may be removable inserted in the sign pocket.

17. The portable sign of claim 14 further comprising a sign pocket whereby an indicia bearing member may be removable inserted in the sign pocket.

18. The portable sign of claim 15 further comprising a sign pocket whereby an indicia bearing member may be removable inserted in the sign pocket.

19. The portable sign of claim 13 wherein the sign pocket is mounted to the collapsible dry-erase section.

20. The portable sign of claim 13 wherein the sign pocket is mounted to a first side of the collapsible dry-erase section opposing a second, dry-erasable mark-up side of the collapsible dry-erase section.
